(19) United States
(12) Patent Application Publication
(10) Pub. No.: US 2018/0241186 A1
(43) Pub. Date: Aug. 23, 2018

(54) Electrical Access System

(71) Applicant: Christmas Northeast, Inc., Trumbull, CT (US)

(72) Inventor: James W. Gibboney, JR., Suches, GA (US)

(73) Assignee: Christmas Northeast, Inc.

(21) Appl. No.: 15/899,722

(22) Filed: Feb. 20, 2018

Related U.S. Application Data
(63) Continuation-in-part of application No. 15/437,106, filed on Feb. 20, 2017, now Pat. No. 9,899,813.

(51) Int. Cl. H02G 3/04; H01R 13/64; H02G 3/06; H01R 11/30

(52) U.S. Cl. CPC H02G 3/0462; H01R 13/64; H02G 3/0418; H01R 9/22; H02G 3/06; H01R 11/30; H02G 3/0437

(57) ABSTRACT

A support is configured to be attached to and supported by a surface and to a channel running from the first end to the opposing second end of the support. The support carries a first electrical connector in a first end of the channel and a second electrical connector, wired to the first, in the opposing, second end of the channel. The first electrical connector is in electrical connection with the second electrical connector via at least one electrical conductor. An electrical current applied to the first electrical connector is conveyed by that electrical conductor to the second electrical connector. Wiring is directed through holed in the support to access points in the outer surface of the support where the user may access electrical current for operating appliances, charging batteries, and passing digital information. The supports may be decorative molding such as baseboards, crown molding, and chair rails.

### TECHNOLOGY FIELD

This disclosure is related generally to the distribution of and access to electricity for users, and, more particularly, for easily-installed electrical access systems for use in connecting appliances, battery charging cables, and for accessing cable and wireless information transmission and reception networks.

### BACKGROUND

The demand for electricity for charging batteries, for electrical power to operate appliances, and for wireless signal transmission has increased significantly. This demand arises in businesses, in residences, in vehicles, and even in the out-of-doors. For example, on commercial aircraft, passengers require power for operating personal computers and recharging mobile devices, for wireless communication with their business offices and for connecting to personal contacts on the ground.

The rapid expansion of the demand for these capabilities has altered the capabilities of homes, offices and vehicles, and has improved the capabilities of these pre-existing structures and vehicles. These improvements may meet the growing demand of today but will likely become inadequate as demand continues to evolve.

In U.S. patent application Ser. No. 15/437,106, Magnetic Repulsion-Based Electrical

Connector, which is incorporated herein in its entirety by reference, teaches a structural electrical power distribution system that uses conduits holding magnetic repulsion connectors to deliver electrical power on an ad hoc basis. This system could be used to provide alternating current or direct current, integrated safety systems, and digital signals useful for control functions and data transfer, including such features as video surveillance, door or gateway monitoring, remote lock control and intercom operation. This system may also be incorporated into structures, such as fencing; and they may be hidden behind decorative molding attached to a wall in order to conceal the existence of electrical power conductors. This system can also include transceiver connections. It may be used to replace extension cords that might otherwise be lying on the floor or ground at work sites, festivals, concerts, flea markets, and parties, where live electrical wires are tripping hazard and a potential fire hazard.

A way to deliver electricity for power and communication purposes that is more fully integrated with existing structures in the environment of use and but flexible in its capabilities would be an advantage.

### SUMMARY

According to its major aspects and briefly recited, the present device includes a support configured to be attached to and supported by a supporting surface. The support has an outer surface, a first end and an opposing second end and a channel running from the first end to the opposing second end. The support carries a first electrical connector in a first end of the channel and a second electrical connector in the opposing, second end of the channel. The first electrical connector is in electrical connection with the second electrical connector via at least one electrical conductor. An electrical current applied to the first electrical connector is conveyed by that electrical conductor to the second electrical connector. Alternatively, the electrical current may be tapped between the first and second electrical connectors in order to deliver needed electrical current for power or signals nearby. Plural supports may be interconnected end to end, much like extension cords, on or within a supporting surface to create a protected concealed path for electrical current delivery. Alternatively, a support may also serve as the supporting surface itself.

An aspect of the disclosure is that the outer surface of the support may have one or more sides for attaching the support to a supporting surface, and the supporting surface may also have one or more surfaces that conform to the one or more sides of the support. The remainder of the outer surface of the support may have a different shape, including a shape that may be decorative. The channel in the support may be completely within the support or be a groove formed in an outer surface of the support.

Another aspect of the disclosure is that the support has a profile on one end that is configured to be joined end to end with an end of a second support.

An aspect of the disclosure is that the device further comprises a conduit that fits inside of the channel.

An aspect of the disclosure is a hole running from the channel to the outer surface of the support and also through the conduit, if present, so that it terminates at the outer surface in a fitting that permits electrical connection with at least one of the conductors in the channel to place the fitting in electrical communication with the electrical connectors. This fitting may be, for example, a universal serial bus port, a wireless router, an electrical socket, a light-emitting diode, an inductance coil, a camera, or other electrical device.

Another aspect of the disclosure is that the support may be part of trim molding, crown molding, a chair rail, a baseboard, corner molding, or a tent pole.

### BRIEF DESCRIPTION OF THE DRAWINGS

In the figures,

FIG. 1 is a perspective view of a work surface having a support in the form of an insert into work surface edge that carries the present electrical access system and which figure shows a mobile device being plugged into a universal serial bus port carried by the insert for recharging the device, according to an aspect of the disclosure;

FIG. 2 is a perspective view of the corner of a room of a residence or office with baseboards and chair rails on its walls, the baseboards and chair rails carrying the present electrical access system according to an aspect of the disclosure;

FIG. 3 is a partial cross-sectional view of portions of three connected conduits with magnetic repulsion electrical connectors for delivering electricity according to an aspect of the disclosure;

FIG. 4 is a cross-sectional view of the magnetic repulsion electrical connectors of

FIG. 3, according to an aspect of the disclosure;

FIG. 5 is an end view of a magnetic repulsion electrical connector showing two terminals and several electrical pin contacts for use in transmitting electrical current as direct current, alternating current or digital pulses, according to an aspect of the disclosure;

FIG. 6 is a schematic diagram of the electrical outputs of plural conduits arranged in sequence in the present electrical access system, according to an aspect of the disclosure;

FIG. 7 is an exterior, partial cross-sectional view of quarter-round trim molding with a conduit inside from which, for example, an LED light may be powered and a universal serial bus port is able to provide recharging capability for mobile devices, according to an aspect of the disclosure;

FIG. 8A, 8B, and 8C illustrate the electrical accesses, namely, an Edison plug as shown in FIG. 8A, a universal serial port as shown in FIG. 8B, and a wireless router antenna as shown in FIG. 8C, according to an aspect of the present disclosure; and

FIG. 9 illustrates a driver-over support on a supporting surface, which may be the ground, with the present conduits embedded in a groove in the support, according to an aspect of the present disclosure.

### DETAILED DESCRIPTION

The device disclosed, which is an electrical access system, is useful as a source of electrical current, unobtrusively embedded in a support, and readily accessible for operating electrical appliances, charging batteries, and data transmission. By providing an electrical access system in, for example, decorative molding, the present device may conveniently replace existing molding or molding that is to be added during interior renovation. The present device requires little in the way of accommodation or cost, and does provide much in the way of convenience in renovating existing space to meet expanding need for access to electrical current.

The term “support” is used herein to refer to a physical object that may be partly decorative and is otherwise functional, inasmuch as its structural value is normally its primary function. The function of the support here, however, is also to convey electrical current for power or for data transmission from one place to another, thereby providing access to electrical current for a variety of uses to those occupying the spaces wherein it is used. Its secondary function is to provide “functional ornamentation” such as serving as trim work by hiding the electrical connectors and conductors it carries and perhaps also hiding joints and seams or protecting walls. The present device may be decorative depending on the particular application and still perform its primary function to good effect.

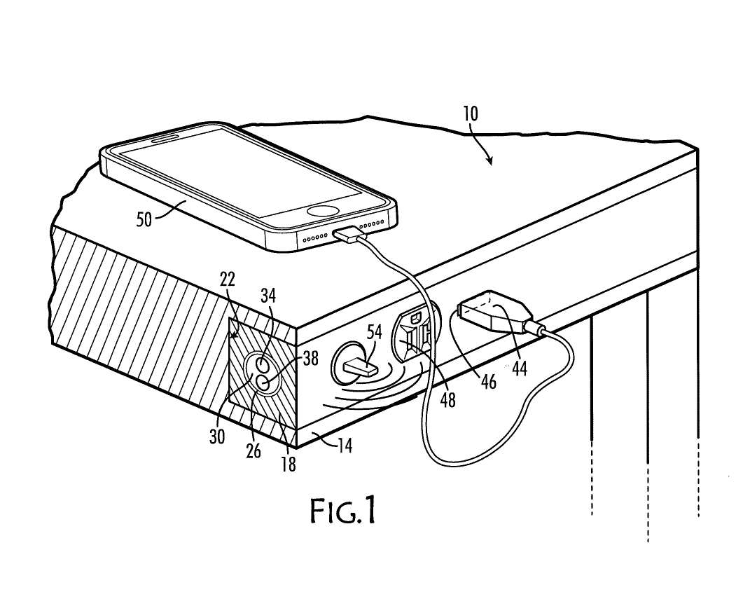

FIG. 1 illustrates an example of the present device. Shown in FIG. 1 is a partially cut away section of a work surface 10, such as a table, desk or countertop. A support 18 according to the present disclosure may have a profile. A profile is a shape in a cross sectional view along at least a portion of a lineal structural member that allows the support to be fitted against or into other structures that have a complementary shape in profile. For example, the edge 14 of work surface 10 may have a recess or channel 22 formed therein, for example, as shown, a wide groove with a square or rectangular cross section. Support 18 may have a complementary shape that enables it to be inserted into that channel 22 so that it appears to be a well-fitting trim piece that completes the finished appearance of work surface 10, while also having the additional, and functional, purpose of delivering electrical current. The term complementary shape is used here to mean that the shape of support 18 is “keyed” to that of edge 14, that is, shaped to fit as a key fits its lock. The shape of support 18 follows the shape of the underlying supporting surface, here, namely work surface 10, so that the two surfaces can be in contact with each other.

Support 18 contains a conduit 26 with magnetic repulsion electrical connectors on each end and wired together to deliver electrical current and data pulses with plural electrical conductors, as will be explained presently. An electrical connector 30 with two contacts 34, 38, as seen in FIG. 1, is connected to a subsequent electrical connector (not shown in FIG. 1, which is identical to electrical connector 30 and its pair of electrical contacts. Conduit 26 delivers electrical current from conduits (not shown) that precede it and transmits to those subsequent conduits to which it is connected.

Between electrical connectors 30 of each conduit 26 are wire pairs from electrical connector 30 that may be connected to access points 42 through a hole in the wall of conduit 26 to the outer surface 28 of support 18 that permit a user to access those electrical currents and both send and receive data pulses via conduits 26. For example, an access point may be a universal serial port 46 accessed by a user using a universal serial port plug for charging a mobile device 50, as shown in FIG, 1, or for connecting a laptop or personal computer to a source of alternating current using a standard (Edison) electrical plug. A router antenna 54 may be still another access point 42 for transmitting and receiving data wirelessly to and from a nearby wireless device, such as mobile device 50.

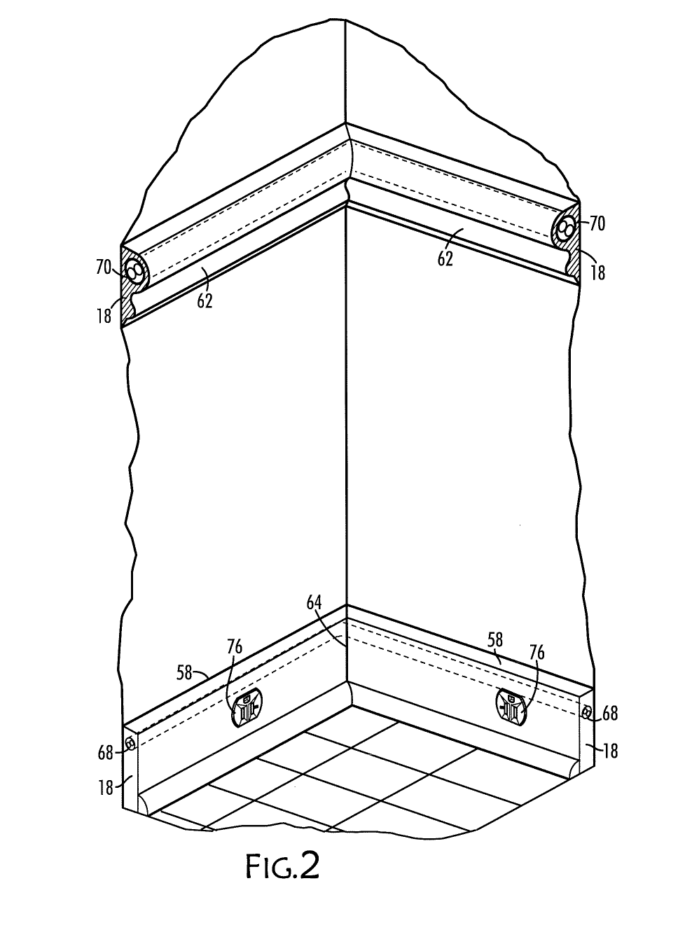

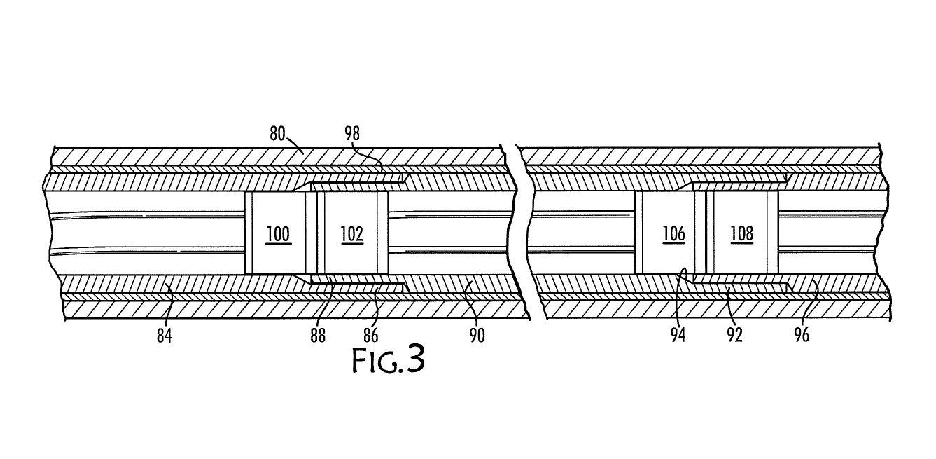

FIG. 2 shows a different aspect of the disclosure of the present disclosure, one in which support 18 is provided for conduits with electrical connectors and access points in the form of decorative molding that primarily serves to hide joints and protect walls from damage, but which also adds ornamentation. Support 18 may be, for example, trim molding, crown molding, chair rails, baseboards, and corner molding.

As seen in FIG. 2, a baseboard 58 and a chair rail 62 are illustrated as examples of supports 18, both partially cut away on their respective ends to show conduits 66, 70, and their electrical connectors 74 and 78 in baseboard, respectively. Baseboard 58 and chair rail 62 may incorporate various access points, such as additional Edison plug socket receptacles 48 shown in baseboard 58.

Baseboard 58 and chair rail 62 may be made to have pre-formed or drilled channels similar to channels 22, into which conduits 26 are inserted. Holes 60 formed, for example, by drilling from the exterior of baseboard 58 or chair rail 62 into conduit 26 enable the installer to pull the wiring from inside conduit 26 so that it connects to access point 42 of the type desired. Access point 42 may be, for example, an Edison socket receptacle 84 that attaches to the wiring pulled from within conduit 26 to secure the socket receptacle 84 to baseboard 58 or chair rail 62. FIG. 2 shows joints 64 and 68 in baseboards 58 and chair rails 62, respectively, where two sections of baseboards 58 or two sections of chair rails 62 are joined in continuing the baseboard 58 and chair rail 62, respectively.

The incorporation of conduits 26 with electrical connectors 74, 78, into trim work that is readily accessible from inside the room, and easily added or replaced, compared to finding, tracing and accessing wiring from inside walls, simplifies installation, modification, renovation, and improvement of the electrical system in pre-existing buildings, such as offices, apartments, commercial establishments, and significantly reduces installation and renovation cost. Existing trim pieces may be replaced with those made according to the present disclosure to add socket receptacles 76 and USB ports 46, and to expand or improve wireless capabilities for users. The presently disclosed conduit 26 may also improve security by providing power to cameras attached to access points in, for example, crown molding or in window frames. Window frames can also carry sensors with wiring that connects to interior window trim and follows conduits 26 in baseboards 58, for example, to control panels or monitors for viewing activities outside the window or for sensing the condition of the window itself, namely, whether open or closed.

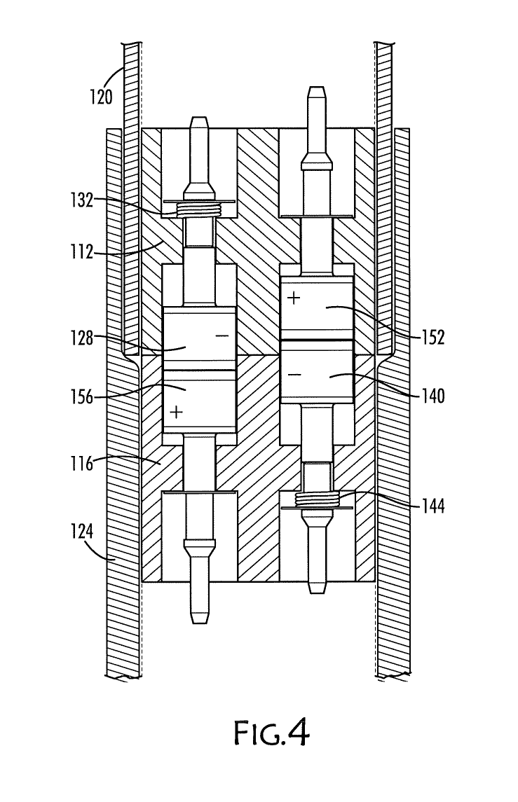

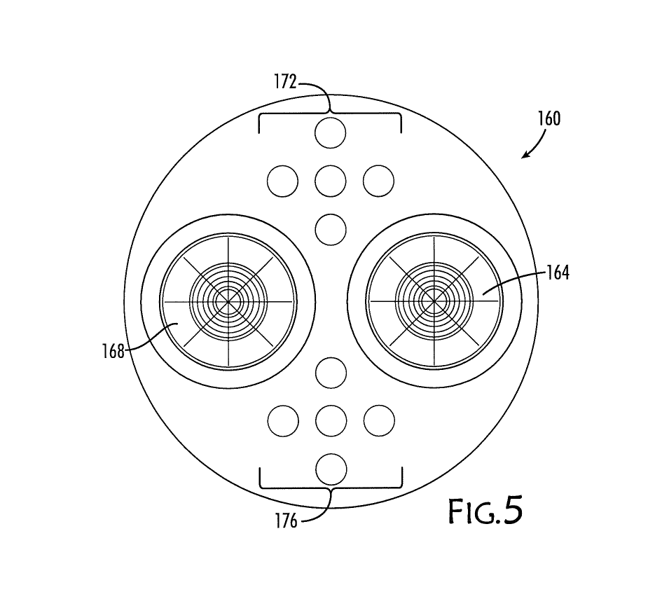

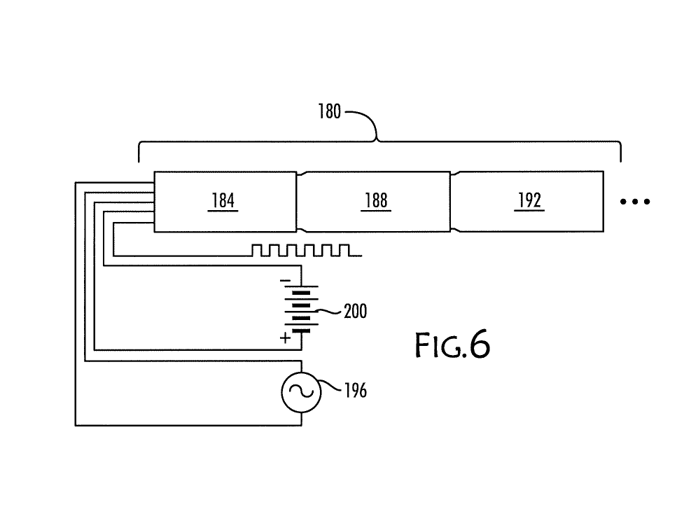

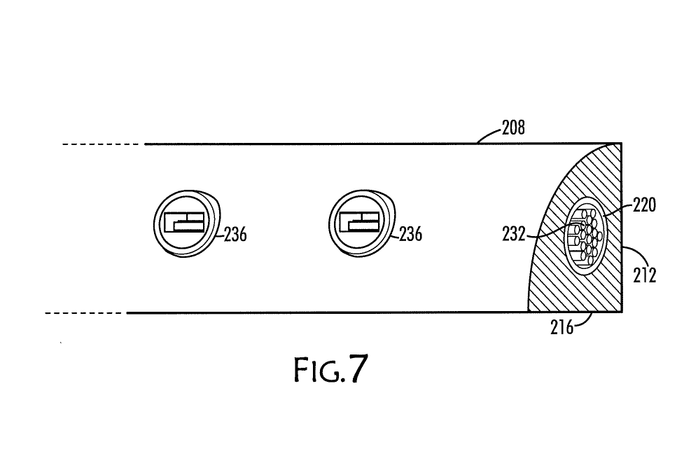

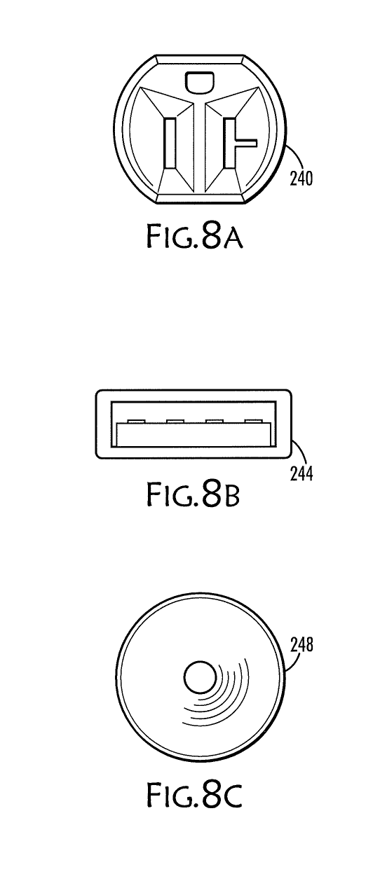

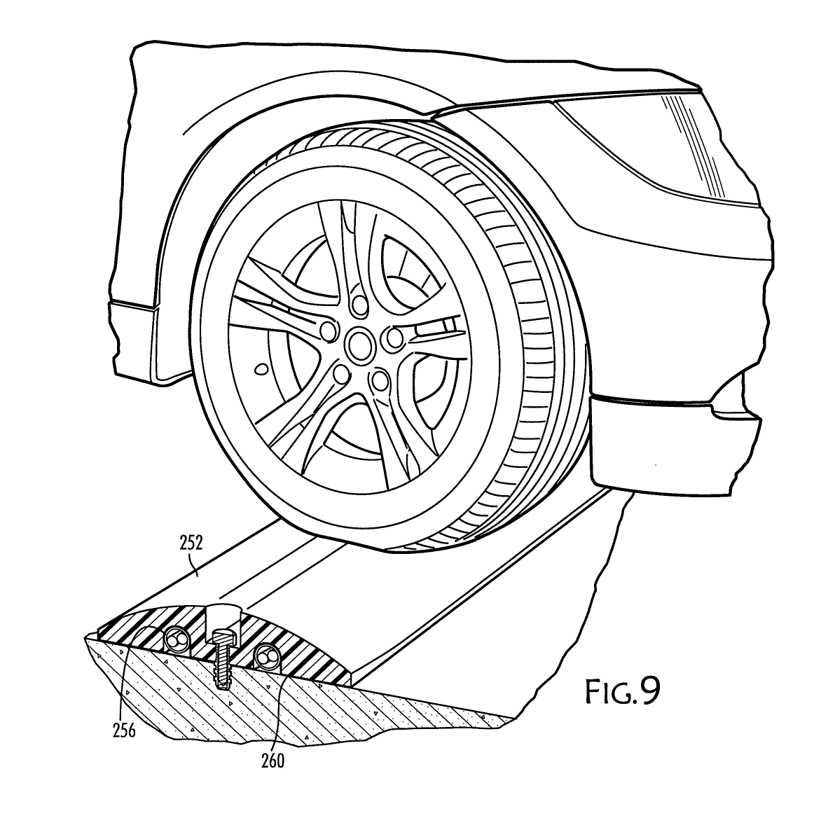

FIGS. 3 and 4 show the details of a group of conduits 26 inside a support 80.

First conduit 84 has a second end 86 (its first end not shown) that is formed to receive a first end 88 of second conduit 90. Second conduit 90 has a second end 92 formed to receive a first end 94 of third conduit 96. Second end 86 and second end 92 may be reduced in thickness, as shown, from that of the balance of first conduit 84 and second conduit 90, respectively, and first end 94 of third conduit 90 may also be reduced in thickness so that first end 88 of second conduit 90 can be received inside of second end 86 of first conduit 84, and first end 94 of third conduit 96 can be received in second end 92 of second conduit 90. Importantly, first conduit 84, second conduit 90, and third conduit 96 nest securely together without complicated connections so that connecting them is quick and effective and they are joined by simply pushing them together without twisting or other orientation requirements.

Support 80 may be made of wood or of solid or foamed plastic with a channel similar to channel 22 that is drilled or extruded therein for insertion of first conduit 84, second conduit 90 and third conduit 96. A liner 98, as shown in FIGS. 3 and 4 may be included to facilitate insertion of first, second and third conduits 84, 90 and 96, respectively. Support 80 may be made of foamed polyvinyl chloride extruded around or over a liner 98 that may be made of metal or solid polyvinyl.

Inside first, second and third conduits 84, 90 and 96 are electrical connectors 100, 102, 106 and 108. Connectors 100 and 102 connect with each other as a pair and connectors 106 and 108 connect with each other as a pair, each pair of connectors 100, 102, 106, and 108, connecting magnetically, orienting themselves by magnetic repulsion, so that good contact is established and electrical polarity may also be preserved.

FIG. 4 illustrates the detail of the connection between two electrical connectors 112 and 114. Electrical connector 112 is held in the end of conduit 120; electrical connector 116 is held near the end of conduit 124 recessed within conduit 124 so that it seats within conduit 124 where the diameter of conduit 124 is slightly wider and not reduced and is therefore able to receive conduit 120, so that the two conduits 120, 124 can be frictionally joined and bring electrical connectors 112 and 116 into contact.

When electrical connectors 112, 116, are brought close together, they orient themselves by magnetic repulsion, twisting so that terminals with opposite polarities are joined. A negative terminal 128 in electrical connector 112 is pulled against a spring 132 a distance above the top surface 136 of electrical connector 112 by magnetic attraction to a positive terminal 152 in electrical connector 116. Likewise a negative terminal 140 of electrical connector 116 is pulled against a spring 144 above a top surface 138 of electrical connector 116 by magnetic attraction to a positive terminal 156 in electrical connector 112. Negative terminal 128 of electrical connector moves to contact a positive terminal 152 which is held in fixed position in electrical connector 116 just as negative terminal 140 moves to contact a positive terminal 156, which is held in fixed position in electrical connector 112. Electrical connection is thus made between electrical connector 112 and electrical connector 116. In addition, electrical connector 112 and electrical connector 116 are locked together against lateral forces because negative terminals 128 and 140 are partially inserted in conduits 124 and 120, respectively, and holding electrical connectors 116 and 112, respectively.

FIG. 5 illustrates an end view of an electrical connector 160. In addition to a negative terminal 164 and a positive terminal 168, additional terminals may be present. For example, there may be two groups, 172 and 176 of four conductive pins that are capable of transmitting digital data pulses in either direction. Other numbers of groups and pins in each group are also possible depending on the requirements dictating the selection of those numbers.

FIG. 6 summarizes in schematic form the electrical current that can be carried by the present conduit or, as shown in FIG. 6, a series 180 of conduits 184, 188, 192. These forms of electrical current include alternating current 196 for household appliances, lighting, computers, televisions, etc., direct current 200 for charging tablet computers and mobile devices, and digital data 204.

FIG. 7 shows “quarter round” molding 208, commonly used to hide seams such as those between floor and wall and between bookcases and walls. Quarter round molding 208, which has two adjacent sides 212, 216, at right angles to each other. Other supports may have one or more flat sides and a curved side. Quarter round molding 208 includes a conduit 220 carrying electrical conductors 224, 228, connecting several pairs of wires 232 each. Wire pairs 232 can be diverted into contact with the backs of access ports 236 at the intervals along quarter round molding 208 or other type, and in the type of access port 236 preferred by the user, including those shown in FIGS. 8A, 8B, and 8C. These figures shown an Edison plug socket with ground connection in FIG. 8A, a universal service bus port 244 in FIG. 8B, and a wireless antenna 248 in FIG, 8C.

Other devices can be attached to the ends of the wire pairs from an electrical connector such as that in FIG. 7 for transmission of electrical current or digital signals in either direction such as lights, including accent lights, safety lighting, and night lights; security cameras; inductance coils; batteries; sensors including motion, heat, and smoke sensors; and solar electric panels.

The present electrical connectors self-align, so installation is much easier. The conduits need only be brought together into alignment and the electrical connectors will then align themselves based on magnetic repulsion so the terminals of opposing polarity lock together. Accordingly, labor cost reductions are achievable in time, in simplicity. Minimal instruction is required for do-it-yourself installation at home and no new skill sets are required for making the connections in commercial installation.

The present electrical access system is ideal for renovating older homes and buildings, for temporarily enhancing the electrical systems of existing buildings and for adding capabilities for temporary events such as outdoor events. As seen in FIG. 9, a support 252 in outdoor applications can be walk-over or drive-over structural members secured end to end, and with conduits 256, 260 embedded safely inside.

Conduits, such as those shown in FIG. 9, may also carry internal controllers, power modifiers, and safety monitors, such as ground fault interrupters. These additional electrical devices may be installed in conduits such as those described above, or in conduits that can be added in-line to meet general requirements based of safety regulations or specific needs. Accordingly, whenever new safety regulations are required, conforming to them may be much easier with the present electricity access system. Conduits may be made out of most any material that will work within the specified application and regulatory requirements. Conduits do not have to be cylindrical, however, they otherwise have to be made to meet or exceed to UL and ANSI standards, and cannot be modified once the magnetic resonance connectors and wiring are installed and the conduits are sealed. Installation may be performed with minimal training. Licensed electricians are not required for consumer or even commercial applications.

In commercial buildings, apartment complexes, residential manufactured housing, and other similar, pre-manufactured or fabricated modular types of construction, the present electrical access system may be specified in advance by architects and installed at the factory where modular wall panels are made. Kits that include portions of the electrical system can be custom-manufactured for these replicated build projects.

Because the present magnetic repulsion-based electrical access system connects itself automatically once workers physically connect them, it saves the cost of having specialists that heretofore were authorized to wire various specialty systems at the jobsite (i.e., electrical, multiline phone systems, burglary systems, cable systems, paging systems , zonal sounds systems, cable antenna driver systems, local repeaters, intercom systems, instrument control systems, Zonal HVAC controllers and thermostats). ,

Because of their universal nature, general purpose conduits may be made in standard lengths (such as 6″, 12″, 18″, 24″, 30″, 36″, 48″, 5′, 10′ sections) with short, dedicated inline taps for accessing AC power USB connectors, networking connections, monitors, televisions, radios; night lights, counter lighting, under counter lighting, dedicated pole lights, etc.

Those skilled in the art of the installation and deployment of electrical devices and appliances in buildings, shelters, and homes will appreciate that many modifications and substitutions may be made in the foregoing description of aspects of the disclosure.

What is claimed is:

1. A device, comprising:
a support having a first end and a second end opposing said first end, said support having channel formed therein and an outer surface;
a first electrical connector in said channel at said first end of said support;
a second electrical connector in said channel at said second end of said support;
at least one electrical conductor connected to said first electrical connector and to said second electrical connector; and
wherein said at least one electrical conductor runs between said first electrical connector and said second electrical connector, said at least one electrical conductor being operable to conduct an electrical current from said first electrical connector to said second electrical connector.

2. The device of claim 1, wherein said outer surface of said support has at least one flat side.

3. The device of claim 1, wherein said outer surface of said support has a profile operable to be attached to a supporting surface with a complimentary profile.

4. The device of claim 1, wherein said device further comprises a conduit lining the inside of said channel, said first electrical connector and said second electrical connector being inside said conduit.

5. The device of claim 1, wherein said first end of said first support has a first configuration and said second end of said first support has a second configuration, said first configuration being complimentary to said second configuration.

6. The device of claim 1, further comprising a fitting carried by said outer surface of said support, said fitting being in electrical communication with said at least one electrical conductor, and wherein said support includes a hole running from said outer surface to said channel, said fitting attached to said outer surface of said support at said hole, said at least one electrical conductor permitting electrical connection to said first electrical connector and said second electrical connector. The device of claim 6, wherein said fitting is a light.

8. The device of claim 6, wherein said fitting is a universal serial bus port.

9. The device of claim 6, wherein said fitting is a wireless router.

10. The device of claim 6, wherein said fitting is an electrical socket.

11. The device of claim 6, wherein said fitting is an inductance coil.

12. The device of claim 6, wherein said fitting is a camera.

13. The device of claim 1, wherein said support is trim molding.

14. The device of claim 1, wherein said support is crown molding.

15. The device of claim 1, wherein said support is a chair rail.

16. The device of claim 1, wherein said support is a baseboard.

17. The device of claim 1, wherein said support is an insert.

18. The device of claim 1, wherein said support is corner molding.

19. The device of claim 1, wherein said support is a tent pole.

20. The device of claim 1, wherein said first electrical connector and said second electrical connector carry pins, said pins of said first electrical connector being operable to transmit data pulses to said pins of said second electrical connector.
